(19) United States
(12) Patent Application Publication
(10) Pub. No.: US 2026/0082341 A1
(43) Pub. Date: Mar. 19, 2026

(54) DISTRIBUTED ANTENNA SYSTEM AND METHOD FOR PROVIDING ULTRA-RELIABLE 5G WIRELESS COVERAGE WITHIN A BUILDING

(71) Applicant: PELTBEAM INC., Sherman Oaks, CA (US)

(72) Inventors: Ahmadreza ROFOUGARAN, Newport Beach, CA (US); Shervin Alireza ODABAEE, Newport Coast, CA (US); Dan Nguyen, Huntington Beach, CA (US); Milan ROFOUGARAN, Newport Coast, CA (US); Kavian Odabaee, Newport Coast, CA (US)

(21) Appl. No.: 18/884,156

(22) Filed: Sep. 13, 2024

(51) Int. Cl. H04W 56/00; H04B 7/145; H04W 24/02

(52) U.S. Cl. CPC H04W 56/0015; H04B 7/145; H04W 24/02

(57) ABSTRACT

A distributed antenna system includes a donor antenna device and a plurality of passive relay antenna devices. The donor antenna device includes a donor antenna to capture 5G RF signals from an outdoor 5G RAN node and transfer the captured 5G RF signals to a radio transceiver circuitry of the donor antenna device to maximize received signal power. The radio transceiver circuitry transmits the captured 5G RF signals as analog RF signals to the plurality of passive relay antenna devices, which receives and wirelessly re-broadcast the 5G RF signals to provide 5G coverage within a building. The donor antenna device and the plurality of passive relay antenna devices executes network time synchronization to the outdoor 5G RAN node based on publicly broadcast synchronization signals in the captured 5G RF signals without explicit coordination from the outdoor 5G RAN node.

### CROSS-REFERENCE TO RELATED APPLICATIONS/INCORPORATION BY REFERENCE

NONE.

### FIELD OF TECHNOLOGY

Certain embodiments of the disclosure relate to a communication system. More specifically, certain embodiments of the disclosure relate to a distributed antenna system and a method for providing ultra-reliable 5G wireless coverage within a building.

### BACKGROUND

Currently, the average data rate is expected to continue increasing in the future as more people adopt new technologies that require high-speed internet. Fixed wireless access (FWA) is a competitive alternative to cable internet and offers several advantages over cable, such as wider availability and lower latency. Currently, telecom companies are bundling mobile services and FWA to compete with cable-based service providers. However, currently, there are many technical issues preventing reliable mobile (cellular signal coverage) and FWA for consumer areas. For example, FWA is currently unavailable in all areas due to the requirement of a clear line of sight between the consumer's location (e.g., home) and the service provider's tower (e.g., the base station). In regions with dense tree cover or buildings, FWA may not be a viable option. Furthermore, the speeds of FWA may fluctuate based on the distance between the consumer's location and the service provider's tower. This variability can impact the quality of the connection. To enhance the overall reliability of both mobile services and FWA for consumer (e.g. residential) use, these technical challenges need to be addressed to offer consistent and widespread coverage.

Further, the advent of fifth generation (5G) technology heralds a significant advancement in network connectivity, such as by offering notably high-speed data rates for internet connections, with decreased latency, and heightened reliability as compared to predecessor technologies. Nevertheless, achieving seamless 5G coverage for indoor locations (e.g., within a building, premises, etc.) poses a considerable challenge due to the signal attenuation and reflection caused by building structures, particularly with signals that may be received from outdoor macro base stations. Further, it is estimated that the majority of all cellular demand comes from mobile users inside of a building. Thus, it's no longer acceptable to have dropped calls, slow downloading and streaming of content, and unresponsive applications needed for business and personal activities. These challenges with in-building wireless connectivity impact the user experience, reputation and business outcomes of an organization. Many entities including property owners may consider installing an in-building distributed antenna system (DAS) to their network to ensure highest performance levels of connectivity inside of buildings.

Furthermore, it is known that Distributed Antenna Systems (DAS) can provide high-speed and reliable wireless connectivity in areas where traditional cellular networks are not able to reach. Conventional Distributed Antenna Systems (DAS) are a common requirement for most building structures. Whether it is a public safety or internet access requirement, a DAS system serves to provide carrier coverage. Although different types of conventional DAS systems exist, for example, indoor DAS, outdoor DAS, hybrid DAS, active DAS and passive DAS, they serve a specific purpose and have different engineering and budgeting constraints. In an example, indoor DAS may be adopted in buildings with poor cellular reception signals, particularly, buildings having signal-blocking materials, such as low-E glass, thick cement walls, and a dense number of users. Typically, in indoor DAS, a signal enters from the base station through a wired carrier feed and disperses throughout the different floors (elevation) of the building. The outdoor DAS may be similar to that of the indoor DAS systems but have weatherproofing. The outdoor DAS may be used in outdoor applications, such as stadiums, resorts, campuses, parks, and the like. The outdoor DAS typically requires Remote Radio Heads (RHHs), which are housed in weatherproof outdoor enclosures and placed on rooftops, poles, or walls to increase outdoor carrier coverage. The hybrid DAS may be a combination of both indoor and outdoor DAS. The indoor portion of the hybrid DAS system may be usually installed inside a building, while the outdoor portion is installed outside the building. The hybrid DAS system may provide coverage for areas that require a dual application through a single system that provides a single zone, bypassing wireless handoff issues. Further, among the most common types of DAS Systems installed today is active DAS, which means that components require a power source, signal amplification with boosters, digitization, and expensive communication medium to operate. The active DAS utilizes fiber optic cables to connect with remote nodes. Typically, to run fiber optics cables within a dwelling requires modification and reconstruction of walls and floors, which may add major expense for deployment. The passive DAS systems are less expensive as compared to the active DAS and typically use passive components like coaxial cable, splitters, and diplexers to distribute signal. Further, unlike the active DAS, the passive DAS systems use bi-directional amplifiers to rebroadcast signal from the macro cellular network using a donor signal on the roof of a building. However, conventional passive DAS systems have many limitations. For example, the conventional passive DAS systems use coax cable to distribute signal, in which signal loss is higher than with active DAS. In the conventional passive DAS systems, the more the antennas are away from the amplifier, the higher the signal loss. The signal loss results in lower downlink output power.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY OF THE DISCLOSURE

A distributed antenna system and a method for providing ultra-reliable 5G wireless coverage within a building, substantially as shown in and/or described in connection with at least one of the figures, as set forth more completely in the claims.

These and other advantages, aspects, and novel features of the present disclosure, as well as details of an illustrated embodiment thereof, will be more fully understood from the following description and drawings.

### BRIEF DESCRIPTION OF DRAWINGS

FIG. 1A is a diagram illustrating a network environment with an outdoor fifth generation (5G) radio access network (RAN) node and distributed antenna systems for providing wireless coverage within one or more sectors, in accordance with an exemplary embodiment of the disclosure.

FIG. 1B is a diagram illustrating a network environment with a distributed antenna system for providing 5G wireless coverage within a building, in accordance with an exemplary embodiment of the disclosure.

FIGS. 2A and 2B are diagrams illustrating communication between a donor antenna device with passive relay antenna devices, in accordance with one or more exemplary embodiments of the disclosure.

FIG. 2C is a diagram illustrating a network environment of a distributed antenna system for providing 5G wireless coverage within a building, in accordance with another exemplary embodiment of the disclosure.

FIG. 3A is a block diagram illustrating a donor antenna device, in accordance with another exemplary embodiment of the disclosure.

FIG. 3B is a diagram illustrating communication between a donor antenna device and a passive relay antenna device in a distributed antenna system, in accordance with an exemplary embodiment of the disclosure.

FIG. 4 is a diagram illustrating communication between a donor antenna device and a passive relay antenna device in a DAS, in accordance with another exemplary embodiment of the disclosure.

FIG. 5 is a flow chart of a method of operating a distributed antenna system for providing 5G wireless coverage within a building, in accordance with an exemplary embodiment of the disclosure.

### DETAILED DESCRIPTION OF THE DISCLOSURE

Certain embodiments of the disclosure may be found in a distributed antenna system for providing 5G wireless coverage within a building. Certain embodiments of the disclosure further provide a method of operating a distributed antenna system for providing 5G wireless coverage within a building.

Unlike the conventional distributed antenna systems, the distributed antenna system of the present disclosure may use an existing home wiring to facilitate 5G connectivity in buildings. The distributed antenna system of the present disclosure enables provisioning a cost-effective bundled 5G mobile and 5G fixed wireless access (FWA) with improved reliability and significant reduction in signal loss (i.e., cable loss) without any cost escalation like the active DAS. The disclosed distributed antenna system do not require any wired carrier feed like conventional indoor DAS and may utilize existing cellular network to distribute cellular signals (e.g., 5G RF signals), within the building to provide robust wireless connectivity throughout a building, while reducing dependency on an overcapacity of signal strength of an outdoor radio access node (e.g., a gNodeB). Beneficially as compared to conventional systems, the distributed antenna system of the present disclosure may be an improved 5G passive distributed antenna system used to distribute 5G RF signals throughout a building without incurring any signal loss or significantly minimizing the signal loss as compared to conventional passive DAS. The distributed antenna system of the present disclosure may also be referred to as an advanced 5G passive distributed antenna system or Super Utility Low-cost TDD Antenna Network (SULTAN), which does not require any active components, such as baseband signal processing, amplifiers or controllers, which makes the distributed antenna system relatively not only simple and cost-effective to install as compared to conventional systems but also reduces latency. The distributed antenna system may be beneficial to provide high-speed and reliable wireless connectivity in areas that traditional cellular networks are not able to reach to improve performance and coverage of 5G RF signals by providing an improved bandwidth for one or more UEs within a building.

In the following description, reference is made to the accompanying drawings, which form a part hereof, and in which are shown, by way of illustration, various embodiments of the present disclosure.

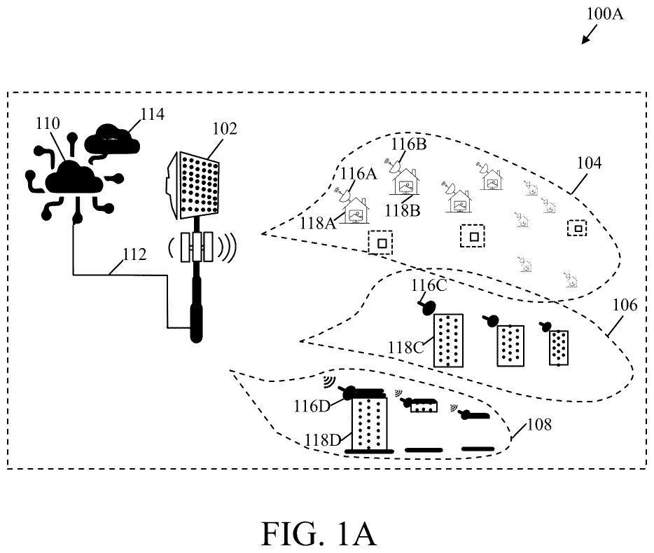

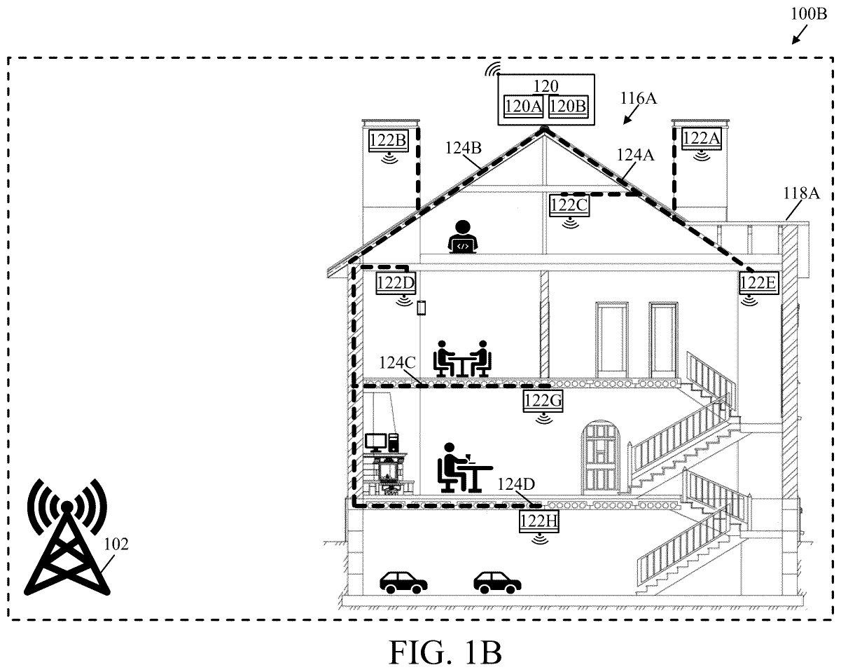

FIG. 1A is a diagram illustrating a network environment with an outdoor fifth generation (5G) radio access network (RAN) node and distributed antenna systems for providing wireless coverage within one or more sectors, in accordance with an exemplary embodiment of the disclosure. With reference to FIG. 1A, there is shown a network environment 100A with an outdoor 5G RAN node 102 for providing wireless coverage within one or more sectors, such as a first sector 104, a second sector 106, and a third sector 108. There is further shown an internet service provider (ISP) 110, fiber optics 112, and a central cloud server 114. There is further shown one or more distributed antenna systems (DAS) 116A to 116D that may be disposed on one or more buildings 118A to 118D respectively.

The outdoor 5G RAN node 102 may be a fixed point of communication that may communicate information, in the form of a plurality of beams of 5G RF signals, to and from different communication devices, such as the one or more distributed antenna systems 116A to 116D. In an implementation, there may exist one or more 5G RAN nodes corresponding to one service provider or multiple service providers, which may be geographically positioned to cover specific geographical areas. Typically, bandwidth requirements serve as a guideline for the location of each 5G RAN node, such as a gNB, based on the relative distance between one or more distributed antenna systems 116A to 116D and the outdoor 5G RAN node 102. The count of 5G RAN nodes may depend on population density and geographic irregularities within an area, such as number of buildings and mountain ranges, which may interfere with the plurality of beams of RF signals. In an implementation, the outdoor 5G RAN node 102 may be a gNodeB (gNB) or a 5G small cell. In another implementation, the outdoor 5G RAN node 102 may include eNBs, Master eNBs (MeNBs) (for non-standalone mode), and gNBs.

In an implementation, each sector from the one or more sectors, such as the first sector 104, the second sector 106, and the third sector 108 may be defined based on a range of frequency of operation. For example, the first sector 104 may be referred to as a mm Wave sector based on the frequency of operation in the mmWave range (e.g., 30-300 GHz). Similarly, the second sector 106 may also be referred to as a C-Band sector based on the frequency of operation in the C-band range (e.g., 3.7 GHZ and 3.98 GHZ). In an implementation, the second sector 106 may also overlap with certain frequencies of the first sector 104, as shown in FIG. 1A. Furthermore, the third sector 108 may also be referred to as a low-band sector based on frequency of operation in lower frequency ranges (e.g., 600 to 700 MHZ).

In an example, the ISP 110 may be configured to provide internet services in high-bandwidth connection (e.g., in terabytes for backhaul) to the outdoor 5G RAN node 102 through the fiber optics 112 (e.g. an optical fiber). Furthermore, the central cloud server 114 may be connected to the internet services provided by the ISP 110 or other service providers. The central cloud server 114 may include suitable logic, circuitry, and interfaces that may be configured to communicate with the outdoor 5G RAN node 102. In an implementation, the central cloud server 114 may be communicatively coupled to the one or more distributed antenna systems 116A to 116D. In an implementation, the central cloud server 114 may be a remote management server that is managed by a third party different from the service providers associated with the plurality of different wireless carrier networks (WCNs). In another example, the central cloud server 114 may be a remote management server or a data center that may be managed by a third party, or maybe jointly managed, or managed in coordination and association with one or more WCNs. In an implementation, the central cloud server 114 may be a master cloud server or a master machine that is a part of a data center that controls an array of other cloud servers communicatively coupled to it for load balancing, running customized applications, and efficient data management.

Each DAS from the one or more DAS 116A to 116D may be a network of antennas strategically placed within a building or area to enhance wireless coverage and capacity, particularly for 5G technologies. For example, the one or more DAS 116A to 116D may be configured to be disposed on the one or more buildings 118A to 118D respectively. In an implementation, a first DAS 116A may be disposed on a first building 118A, a second DAS 116B may be disposed on a second building 118B, a third DAS 116C may be disposed on a third building 118C, and a fourth DAS 116D may be disposed on a fourth building 118D. In an implementation, there may exist an N-number of DASs, which may be disposed in different sectors, such as in the first sector 104, the second sector 106, and the third sector 108. Furthermore, each DAS from the one or more DAS 116A to 116D may be configured to extend 5G RF signal coverage from the outdoor 5G RAN node 102 to multiple passive antenna nodes, which may be dispersed throughout the building or area to provide uniform coverage of 5G signals. Each DAS from the one or more DAS 116A to 116D may be configured for utilizing existing home wiring systems (e.g., coaxial cables or Ethernet cables) to facilitate 5G connectivity throughout the building or nearby areas to provide uniform coverage. The one or more DAS 116A to 116D may be a common requirement for most building structures. Whether it is a public safety, code, or building comfort/experience, or internet access requirement, such as to provide and improve carrier coverage. Each DAS, such as the first DAS 116A, may be further configured to provide wireless connectivity throughout the first building 118A, while reducing dependency on overcapacity of nearby mobile towers, such as the outdoor 5G RAN node 102. An exemplary implementation of the first DAS is further shown and described, for example, in FIG. 1B.

Generally, 5G technology utilizes three primary spectrum ranges: low-band (e.g., low-band 5G utilizes the spectrum below 1 GHz, typically 600 MHz to 1 GHz), mid-band (e.g., includes C-Band and may operate in the 2.4 GHz to 4.2 GHZ), and high-frequency bands (e.g., 24 GHz to 39 GHz range, or other F2 range of 5G NR). Each range offers distinct capabilities and performance trade-offs, allowing for tailored solutions based on specific requirements. The low-band spectrum provides extensive coverage but at comparatively lower speeds, not significantly faster than 4G LTE networks from an end-user perspective. In contrast, the high-band spectrum (mmWave) delivers staggeringly rapid data rates, but its range is limited, and it struggles to penetrate solid structures like buildings effectively. Occupying the middle ground between these two extremes is the C-Band, a mid-band spectrum that strikes a balance, offering a blend of reasonable coverage and speed capabilities that fall between the high and low extremes. Each of the one or more distributed antenna systems 116A to 116D may be configured to operate in the mid-band and the high-frequency bands concurrently or alternatively in different sectors.

Each of the one or more distributed antenna systems 116A to 116D may be configured to capture 5G cellular signals via a donor antenna device from an existing cellular network, such as the outdoor 5G RAN node 102, and rebroadcast the captured 5G signals inside any dwelling (e.g., the one or more buildings 118A to 118D) using a plurality of relay antennas. By rebroadcasting the captured 5G signals inside the buildings, the solution aims to provide a strong and reliable 5G signal in every room. This enhanced coverage enables better connectivity for mobile devices within the buildings. The improved 5G signal strength and coverage within the buildings also benefits CPE and mobile hotspots. These devices can convert the 5G signal into a Wi-Fi network, allowing users to connect their Wi-Fi-enabled devices to the internet using the 5G network as the backbone.

Beneficially, each of the distributed antenna systems 116A to 116D employs a distinctive approach that differentiates the one or more distributed antenna systems 116A to 116D from conventional systems. For instance, the donor antenna of each of the distributed antenna systems 116A to 116D may be embedded within the antenna module itself, enabling the system to capture maximum power from the outdoor 5G RAN node 102 (e.g., gNB) without incurring any cable loss. Such configuration may result in higher sensitivity and better reception as the signal strength is maintained from the source to the antenna module. Second, the donor antenna may feed an existing cable of each building, which then transmits the signal to the relay antennas. Since the relay antennas may be equipped with their own receive amplifiers, there is no need for the donor antenna to overdrive the cable, preventing signal distortion and maintaining signal quality. Third, the downlink performance may be optimized by efficiently distributing and balancing the gain between the donor antenna and the relay antennas. This intelligent management ensures that the signal is evenly distributed throughout the coverage area, providing a consistent and reliable 5G experience for users. Furthermore, this approach extends to the uplink transmission as well, particularly benefiting from the proximity of the transmitter power amplifier (PA) to the donor antenna. In some implementations, by incorporating four donor antennas within each distributed antenna system, the system may take advantage of beamforming or power combining in the air. This capability provides a substantial advantage over traditional and costly booster systems, as it allows for more focused and directed signal transmission, enhancing the overall performance and coverage of the 5G network within the buildings.

FIG. 1B is a diagram illustrating a network environment with a distributed antenna system for providing 5G wireless coverage within a building, in accordance with an exemplary embodiment of the disclosure. FIG. 1B is explained in conjunction with elements from FIG. 1A. With reference to FIG. 1B, there is shown a network environment 100B that may include the outdoor 5G RAN node 102 and the first DAS 116A of FIG. 1A. The first DAS 116A may include a donor antenna device 120 and a plurality of passive relay antenna devices 122A to 122H. There is further shown one or more wired mediums 124A to 124D.

The donor antenna device 120 may include a donor antenna 120A and a radio transceiver circuitry 120B, which may be integrated and connected with the donor antenna 120A independent of a physical cable. In an implementation, the donor antenna 120A may be an antenna that may operate in one or more of a C-band, FR1 band of 5G NR, FR2 band of 5G NR, LTE band, and the like. In an implementation, the donor antenna 120A may be a patch antenna. In an implementation, the donor antenna 120A may be a phase-array antenna, an individual antenna, an XG phased-array antenna panel, an XG-enabled antenna chipset, an XG-enabled patch antenna array, or an XG-enabled servo-driven antenna array, where the “XG” refers to 5G or 6G. Examples of implementations of the XG phased-array antenna panel include, but are not limited to, a linear phased array antenna, a planar phased array antenna, a frequency scanning phased array antenna, a dynamic phased array antenna, and a passive phased array antenna. Similarly, the radio transceiver circuitry 120B may include suitable logic, circuitry, and interfaces that may be configured to communicate with the donor antenna 120A. In an implementation, the radio transceiver circuitry may include a transceiver, a multiplexer, a mixer, and a controller.

The plurality of passive relay antenna devices 122A to 122H may be distributed throughout the first building 118A at a plurality of different locations and communicatively coupled to the donor antenna device 120 via the one or more wired mediums 124A to 124D. Each passive relay antenna device of the plurality of passive relay antenna devices 122A to 122H may include a series of passive antennas to receive cellular signals from the donor antenna device 120 and amplify and distribute the received cellular signals throughout the first building 118A (e.g., through a series of passive antennas that may be placed within the first building 118A). By using the plurality of passive relay antenna devices 122A to 122H, the first DAS 116A may also be referred to as a passive DAS system, which does not require any active components which makes them relatively simple and cost-effective to install as compared to conventional active DAS.

The one or more wired mediums 124A to 124D may be configured to provide connectivity between the donor antenna device 120 and the plurality of passive relay antenna devices 122A to 122H. For example, a first wired medium 124A may be configured to provide connectivity between the donor antenna device 120 and the first passive relay antenna device 122A. Similarly, a second wired medium 124B may be configured to provide connectivity between the donor antenna device 120 and the second passive relay antenna device 122B. Examples of implementation of the one or more wired mediums 124A to 124D may include but are not limited to a coaxial cable or an Ethernet cable installed within the building. In an implementation, a few of the one or more wired mediums 124A to 124D may be an existing wired medium installed in the first building 118A, which may be beneficial to reduce an overall cost of implementation.

In operation, the donor antenna 120A of the donor antenna device 120 may be configured to capture 5G RF signals from the outdoor 5G RAN node 102 and transfer the captured 5G RF signals to the radio transceiver circuitry 120B independent of cable loss to maximize received signal power. In an implementation, the donor antenna 120A may be strategically designed and positioned to efficiently capture the 5G RF signals from the outdoor 5G RAN node 102. In an implementation, antenna design considerations may include an antenna type (e.g., directional, omnidirectional), antenna gain, polarization capability of the antenna, and frequency range of the antenna compatibility with the 5G RF signals. In an implementation, the design of the donor antenna 120A may be beneficial to optimize the 5G RF signal reception, such as a directional antenna focusing on the 5G RF signals from a specific direction or omnidirectional antennas capturing the 5G RF signals from all directions. Furthermore, once the donor antenna 120A captures the 5G RF signals, thereafter, signal processing may be employed for the 5G RF signals, such as to filter out noise and interference, ensuring that only the desired 5G RF signals are retained for further processing. Thereafter, the donor antenna 120A may be configured to transfer the captured 5G RF signals to the radio transceiver circuitry 120B without any cable loss (i.e., no signal loss) to maximize received signal power. In an implementation, the captured 5G RF signals are transferred directly to the radio transceiver circuitry 120B.

The radio transceiver circuitry 120B may be configured to transmit the captured 5G RF signals as analog RF signals over the one or more wired mediums 124A to 124D to the plurality of passive relay antenna devices 122A to 122H. In an implementation, the radio transceiver circuitry 120B may be configured to first convert the captured 5G RF signals into the analog RF signals (e.g., using a mixer), such as to allow for compatibility with the one or more wired mediums 124A to 124D and also to ensure seamless transmission over the one or more wired mediums 124A to 124D. The analog RF signals may be then transmitted by the radio transceiver circuitry 120B (e.g., through a multiplexer) over the one or more wired mediums 124A to 124D to the plurality of passive relay antenna devices 122A to 122H. In an implementation, the one or more wired mediums 124A to 124D may be one of a coaxial cable or an Ethernet cable, which is already installed within the building (e.g., the first building 118A). Therefore, the one or more wired mediums 124A to 124D may have lower signal loss as compared to wireless transmission, especially over long distances, which may result in improved signal quality and improved data transmission rates. Furthermore, by using existing ethernet cables, the overall operational cost may be reduced.

In an implementation, the radio transceiver circuitry 120B may be configured to convert the 5G RF signals captured from the outdoor 5G RAN node 102 in a first 5G frequency spectrum to a second 5G frequency spectrum for transmission of the captured 5G RF signals as analog RF signals over the one or more wired mediums 124A to 124D to the plurality of passive relay antenna devices 122A to 122H. The radio transceiver circuitry 120B may act as an intermediary between the outdoor 5G RAN node 102 and the plurality of passive relay antenna devices 122A to 122H, such as the 5G RF signals are captured from the outdoor 5G RAN node 102 (e.g., by the donor antenna 102A) in the first 5G frequency spectrum and converted into the second 5G frequency spectrum. In an implementation, the first 5G frequency spectrum may also be referred to as a mid-band spectrum including C-band or 5G high-band spectrum (mmWave) and the second 5G frequency spectrum may also be referred to as an ISM band, or other licensed or unlicensed band suitable for coaxial cable transmission and also depending on use case to reduce interference. In an implementation, the radio transceiver circuitry 120B may be configured to use different frequency conversion techniques, such as mixing, filtering, and amplification, which may be employed to convert the 5G RF signals captured from the outdoor 5G RAN node 102 in the first 5G frequency spectrum to the second 5G frequency spectrum. By converting the first 5G frequency spectrum into the second 5G frequency spectrum, the radio transceiver circuitry 120B may prepare the 5G RF signals for seamless and efficient transmission of the 5G RF signals over the one or more wired mediums 124A to 124D and to the passive relay antenna devices 122A to 122H. The frequency conversion may be beneficial to align the 5G RF signals with an optimal frequency range for transmission over the one or more wired mediums 124A to 124D ensuring minimal signal loss and interference. Furthermore, transmitting the 5G RF signals in analog RF format over the one or more wired mediums 124A to 124D may enhance reliability and stability of the 5G RF signals, such as in environmental conditions where wireless transmission may be prone to interference or signal degradation may occur. In addition, by leveraging frequency conversion and wired transmission, the first DAS 116A may extend 5G RF signals coverage within the first building 118A or across larger areas, providing consistent and high-quality connectivity to end users within the first building 118A, ultimately enhancing the overall performance and reliability of the first DAS 116A.

The plurality of passive relay antenna devices 122A to 122H may be configured to receive the analog RF signals from the donor antenna device 120 and wirelessly re-broadcast the 5G RF signals to provide 5G coverage within the building. In an implementation, each passive relay antenna device may be configured to be disposed in any existing building with preexisting wiring such as co-axial cables and ethernet cables. The plurality of passive relay antenna devices 122A to 122H are beneficial for the distribution of the analog RF signals into dwellings while reducing reconstruction or rewiring expenses without using any amplifier or controller. By re-broadcasting the analog 5G RF signals, each passive relay antenna device may facilitate comprehensive coverage of the 5G RF signals within the first building 118A, which may ensure that all areas receive adequate signal strength for reliable connectivity. In an implementation, the first passive relay antenna device 122A may provide comprehensive coverage of the 5G RF signals on a top floor of the first building 118A. In another implementation, another passive relay antenna device 122H may provide comprehensive coverage of the 5G RF signals on a lower ground floor of the first building 118A without the need for additional wired connections. As a result, the wireless re-broadcasting of the 5G RF signals may extend coverage into different areas where direct reception from the donor antenna 120A may be limited or obstructed, enhancing connectivity throughout the first building 118A. Therefore, the plurality of passive relay antenna devices 122A to 122H may provide flexibility and scalability in network deployment, allowing for the adaptation of coverage of the 5G RF signals based on the layout of the first building 118A, user density, and signal propagation characteristics. By leveraging plurality of passive relay antenna devices 122A to 122H to distribute the 5G RF signals, an optimal coverage and performance is achieved, enhancing user experience while supporting a wide range of applications and services within the building environment.

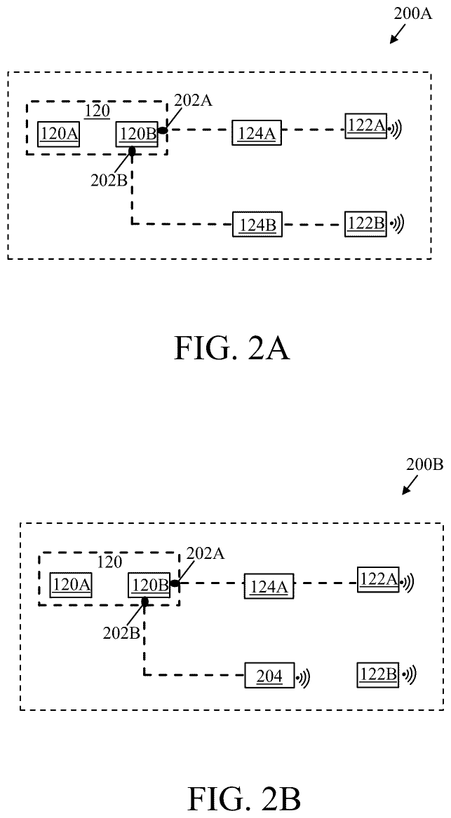

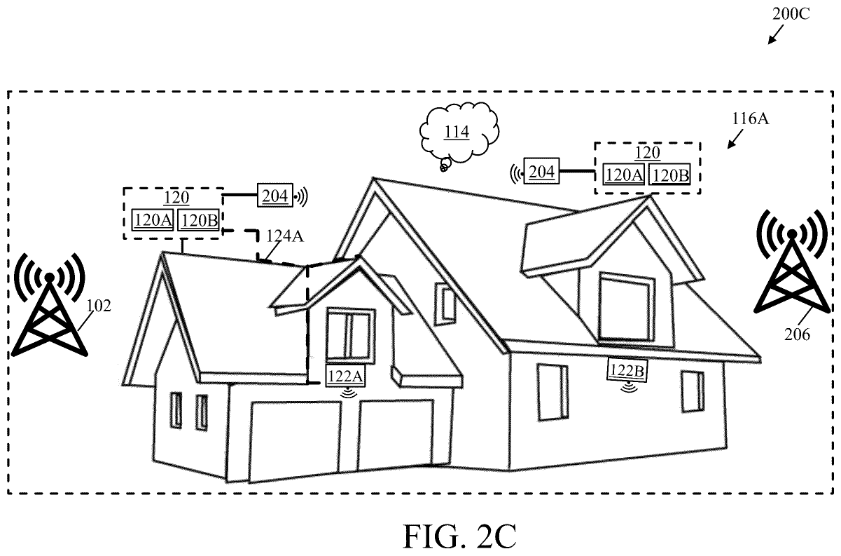

The donor antenna device 120 and the plurality of passive relay antenna devices 122A to 122H may be configured to execute network time synchronization to the outdoor 5G RAN node 102 based on publicly broadcast synchronization signals in the captured 5G RF signals without explicit coordination from the outdoor 5G RAN node. In an implementation, the publicly broadcast synchronization signals may be embedded within the captured 5G RF signals. Furthermore, the donor antenna device 120 and the plurality of passive relay antenna devices 122A to 122H may be configured to analyze the publicly broadcast synchronization signals, such as to extract timing information from the publicly broadcast synchronization signals, while reducing the complexity and overhead associated with explicit coordination mechanisms. Thereafter, the donor antenna device 120 and the plurality of passive relay antenna devices 122A to 122H may be configured to execute the network time synchronization to the outdoor 5G RAN node 102. Executing the network time synchronization without explicit coordination from the outdoor 5G RAN node 102 may enhance the efficiency and reliability of the donor antenna device 120 and the plurality of passive relay antenna devices 122A to 122H. Furthermore, synchronized timing among the donor antenna device 120 and the plurality of passive relay antenna devices 122A to 122H may be beneficial for various functions, including efficient resource allocation, interference mitigation, and handover management, ultimately improving network performance and user experience. As a result, synchronization within the donor antenna device 120 and the plurality of passive relay antenna devices 122A to 122H may be beneficial to improve overall reliability, such as by receiving an improved 5G RF signal power. Such network time synchronization may endorse interoperability and scalability in heterogeneous network environments, where more than one number of donor antenna devices and N-number of passive relay antenna devices may operate without explicit coordination from the outdoor 5G RAN node 102, which may lead to more seamless integration and deployment of 5G networks in diverse settings. An exemplary implementation of a scenario with two different donor antenna devices is further shown and described in FIG. 2B. In an implementation, the donor antenna device 120 and the plurality of passive relay antenna devices 122A to 122H may be configured to synchronize corresponding internal clocks with the outdoor 5G RAN node 102. By aligning corresponding internal clocks with the timing reference provided by the outdoor 5G RAN node 102, the donor antenna device 120 and the plurality of passive relay antenna devices 122A to 122H may ensure coordination and coherence within the first DAS 116A. The donor antenna device 120 and the plurality of passive relay antenna devices 122A to 122H may be configured to perform time division duplex (TDD) synchronization in the network, where the same frequency may be used for each duplex direction.

Unlike the conventional distributed antenna system, the first DAS 116A of the present invention may use an existing cellular network to distribute the 5G RF signals within the first building 118A, such as to provide robust wireless connections throughout the first building 118A, while reducing dependency on overcapacity of signal strength of the outdoor 5G RAN node 102. Beneficially as compared to conventional systems, the first DAS 116A may be configured to use the donor antenna device 120 and the plurality of passive relay antenna devices 122A to 122H to amplify and distribute the 5G RF signals throughout the first building 118A. The first DAS 116A may also be referred to as an advanced 5G passive distributed antenna system, which does not require any active components, such as amplifiers or controllers, which makes the first DAS 116A relatively simple and cost-effective to install as compared to conventional systems. The first DAS 116A may also be beneficial to provide high-speed and reliable wireless connectivity in areas where traditional cellular networks are not able to reach, such as to provide an improved performance and coverage of 5G RF signals by providing an improved capacity and improved bandwidth for one or more UEs within the first building 118A.

FIGS. 2A and 2B are diagrams illustrating communication between a donor antenna device with passive relay antenna devices, in accordance with one or more exemplary embodiments of the disclosure. The FIGS. 2A and 2B are explained in conjunction with elements from FIG. 1A and FIG. 1B. With reference to FIG. 2A, there is shown a diagram 200A that depicts communication between the donor antenna device 120 with the first passive relay antenna device 122A and with the second passive relay antenna device 122B. There is further shown that the donor antenna device 120 may include a first signal output port 202A and a second signal output port 202B, each connected to the radio transceiver circuitry 120B of the donor antenna device 120. With reference to FIG. 2B, there is shown a diagram 200B that depicts an RF antenna 204 coupled to the second signal output port 202B of the donor antenna device 120.

In an implementation, the donor antenna device 120 may include a first signal output port 202A and a second signal output port 202B, each connected to the radio transceiver circuitry 120B for concurrent relay of the captured 5G RF signals as analog 5G RF signals over the one or more wired mediums 124A to 124D from the donor antenna device 120. In an implementation, the first wired medium 124A may be configured for providing connectivity between the donor antenna device 120 and the first passive relay antenna device 122A, such as through the first signal output port 202A. Similarly, the second wired medium 124B may be configured for providing connectivity between the donor antenna device 120 and the second passive relay antenna device 122B, such as through the second signal output port 202B, as shown in FIG. 2A. In another implementation, the RF antenna 204 coupled to the second signal output port 202B of the donor antenna device 120 may also be configured for providing connectivity between the donor antenna device 120 and the second passive relay antenna device 122B, as shown in FIG. 2B. The first signal output port 202A may be connected to the first passive relay antenna device 122A of the plurality of passive relay antenna devices 122A to 122H via the first wired medium 124A to serve a first zone in the building (e.g., the first building 118A). In addition, the second signal output port 202B may be connected to the second passive relay antenna device 122B of the plurality of passive relay antenna devices 122A to 122H via the second wired medium 124B to serve a second zone in the building (e.g., the first building 118A). As each of the first signal output port 202A and the second signal output port 202B are connected to the radio transceiver circuitry 120B, the radio transceiver circuitry 120B may perform concurrent relay of analog 5G RF signals over the one or more wired mediums 124A to 124D to serve distinct zones within the first building 118A. By using the first signal output port 202A and the second signal output port 202B, the donor antenna device 120 may optimize signal distribution efficiency and coverage versatility of the captured 5G RF signals. In an implementation, the donor antenna device 120 may include more than two ports, which may improve network flexibility, enabling tailored coverage solutions for different areas within the first building 118A, while maintaining seamless connectivity and maximizing the utilization of the one or more wired mediums 124A to 124D.

In an implementation, the donor antenna device 120 may include the first signal output port 202A and the second signal output port 202B, each connected to the radio transceiver circuitry 120B for concurrent relay of the captured 5G RF signals as analog RF signals in a hybrid wired and wireless medium from the donor antenna device 120. The first signal output port 202A may be connected to the first passive relay antenna device 122A of the plurality of passive relay antenna devices 122A to 122H via the first wired medium 124A to serve a first zone in the building (e.g., the first building 118A). In addition, the second signal output port 202B may be connected to the RF antenna 204, which may be configured to relay a wireless radio frequency signal towards the second passive relay antenna device 122B of the plurality of passive relay antenna devices 122A to 122H to serve a second zone in the building (e.g., the first building 118A). The RF antenna 204 may be beneficial for augmentation and coverage of the analog 5G RF signals and provide flexibility within the first building 118A. By using the RF antenna 204, the donor antenna device 120 may extend coverage of the analog 5G RF signals beyond the limitations of the one or more wired mediums 124A to 124D, facilitating seamless connectivity of the analog 5G RF signals to one or more zones that may be challenging to reach through the one or more wired mediums 124A to 124D. The RF antenna 204 of the donor antenna device 120 may improve the adaptability of wireless network deployment, allowing for dynamic adjustments and expansions in coverage without the need for additional infrastructure installation. Moreover, the RF antenna 204 of the donor antenna device 120 may enable efficient utilization of resources by optimizing 5G RF signal distribution and minimizing deployment costs, enhancing the overall performance and reliability of the 5G RF signal within the building, such as the first building 118A.

FIG. 2C is a diagram illustrating a network environment of a distributed antenna system for providing 5G wireless coverage within a building, in accordance with an exemplary embodiment of the disclosure. FIG. 2C is explained in conjunction with elements from FIGS. 1A, 1B, 2A, and FIG. 2B. With reference to FIG. 2C, there is shown a diagram 200C that depicts the outdoor 5G RAN node 102 and another outdoor 5G RAN node 206. There is further shown the central cloud server 114.

In an implementation, the donor antenna 120A of the donor antenna device 120 may be further configured to switch between two different carrier frequencies from two different wireless carrier networks for the capture of the 5G RF signals alternatively from two different RAN nodes (e.g., two different gNB of different telecom carriers) based on an instruction received from the central cloud server 114. With reference to FIG. 2C, there is shown that the donor antenna 120A of the donor antenna device 120 may be configured to receive a first instruction from the central cloud server 114, such as to capture the 5G RF signals from the outdoor 5G RAN node 102 in a first carrier frequency. In addition, the donor antenna 120A of the donor antenna device 120 may also be configured to receive a second instruction from the central cloud server 114, such as to capture the 5G RF signals from the other outdoor 5G RAN node 206 in a second carrier frequency. This dynamic switching capability allows the donor antenna 120A to capture 5G RF signals from multiple RAN nodes, facilitating improved coverage, load balancing, and resilience within the network infrastructure. Moreover, the ability to receive the instructions from the central cloud server 114 enables centralized management and control, enabling real-time adjustments to meet evolving network demands and optimize performance. Thereafter, the donor antenna 120A of the donor antenna device 120 may be configured to transfer the 5G RF signals captured from the outdoor 5G RAN node 102 as well as from the other outdoor 5G RAN node 206 to the radio transceiver circuitry 120B independent of cable loss to maximize received signal power. In addition, the radio transceiver circuitry 120B may be configured to transmit the 5G RF signals as received from the outdoor 5G RAN node 102 as analog RF signals over the first wired medium 124A to the first passive relay antenna device 122A, such as to serve the first zone in the first building 118A. In an implementation, the radio transceiver circuitry 120B may be configured to transmit the 5G RF signals as received from the outdoor 5G RAN node 102 as analog 5G RF signals through the RF antenna 204 and to the first passive relay antenna device 122A, such as to serve the first zone in the first building 118A. In other words, the RF antenna 204 may be configured to relay the 5G RF signals towards the first passive relay antenna device 122A to serve the first zone in the first building 118A. Similarly, the radio transceiver circuitry 120B may be configured to transmit the 5G RF signals as received from the other outdoor 5G RAN node 206 as analog 5G RF signals through the RF antenna 204 and to the second passive relay antenna device 122B, such as to serve the second zone in the first building 118A. Due to the seamlessly transitioning between two different carrier frequencies based on the instructions received from the central cloud server 114, the donor antenna device 120 may optimize signal acquisition efficiency and network resource utilization. This approach enhances the flexibility and scalability of 5G RF signals deployment, ensuring robust and efficient operation in diverse environments and scenarios.

In an implementation, the donor antenna 120A of the donor antenna device 120 may be configured to concurrently receive two different carrier frequencies from two different wireless carrier networks for concurrent capture of the 5G RF signals from two different RAN nodes based on an instruction received from the central cloud server 114. By concurrently capturing the 5G RF signals from two different RAN nodes, the donor antenna 120A maximizes network coverage and capacity, ensuring comprehensive connectivity and optimal utilization of available spectrum resources. This concurrent reception capability of the donor antenna 120A may be beneficial to dynamically adapt to changing network conditions and traffic patterns, optimizing signal acquisition efficiency and network performance. Additionally, by leveraging multiple carrier frequencies, the donor antenna 120A enhances resilience and redundancy, mitigating the impact of potential network disruptions or congestions. Overall, this approach improves the reliability, flexibility, and scalability of the first DAS 116A, providing robust and efficient 5G RF signal connectivity in diverse deployment scenarios.

In an implementation, the radio transceiver circuitry 120B may be further configured to aggregate the 5G RF signals from the two different RAN nodes into a single composite signal stream for transmission as the analog RF signals over the one or more wired mediums 124A to 124D to the plurality of passive relay antenna devices 122A to 122H. By aggregating the 5G RF signals from two different RAN nodes into a single composite signal stream, the radio transceiver circuitry 120B may facilitate streamlines signal transmission over the one or more wired mediums 124A to 124D to the plurality of passive relay antenna devices 122A to 122H, with improved efficiency and resource utilization. Furthermore, by aggregating the 5G RF signals from the two different RAN nodes into the single composite signal stream, the donor antenna 120A optimizes bandwidth usage and reduces potential congestion on the one or more wired mediums 124A to 124D. This may result in improved throughput, reduced latency, and enhanced overall performance of the donor antenna 120A within the coverage area (e.g., in the first building 118A). Additionally, the aggregation process simplifies network management and maintenance by reducing the complexity associated with handling multiple signal streams, as a result contributing to an extra robust and scalable distributed antenna system (e.g., the first DAS 116A).

In an implementation, each of the donor antenna device 120 and the plurality of passive relay antenna devices 122A to 122H may further be configured to adjust at least one operating parameter based on a control instruction received from the central cloud server 114. In an implementation, the at least one operating parameter may include one or more of: a gain level at each of the plurality of passive relay antenna devices, a routing path among the plurality of passive relay antenna devices 122A to 122H, a channel allocation, a bandwidth allocation, a beamforming parameter, and an antenna combining instruction. By dynamically adjusting the operating parameters, such as adjusting the gain levels, routing paths, channel and bandwidth allocations, beamforming parameters, and antenna combining instructions, each of the donor antenna device 120 and the plurality of passive relay antenna devices 122A to 122H can effectively respond to changing network conditions and changing demands in real-time. This adaptive capability enables each of the donor antenna device 120 as well as the plurality of passive relay antenna devices 122A to 122H to optimize signal transmission, coverage, and capacity, maximizing network performance and user experience. Additionally, centralized control from the central cloud server 114 streamlines network management and configuration, facilitating efficient resource utilization and minimizing operational overhead. As a result, such dynamic adjustment of operating parameters may improve the flexibility, efficiency, and scalability of the DAS (e.g., the first DAS 116A), ensuring robust and reliable 5G connectivity in various deployment scenarios.

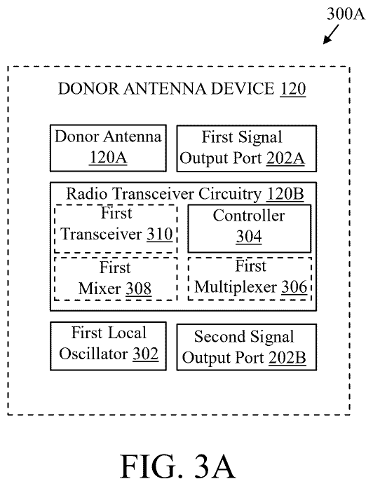

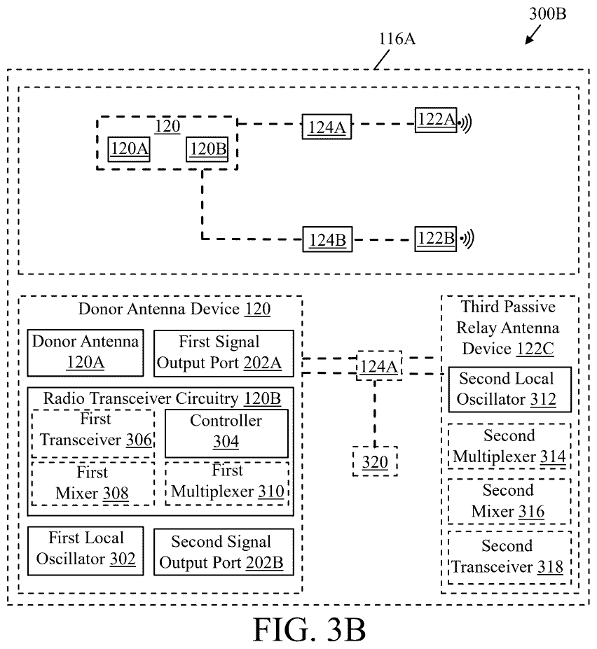

FIG. 3A is a block diagram illustrating a donor antenna device, in accordance with an exemplary embodiment of the disclosure. The FIG. 3A is explained in conjunction with elements from FIGS. 1A, 1B, 2A, 2B, and FIG. 2C. With reference to FIG. 3A, there is shown a diagram 300A that depicts the donor antenna device 120, which may include a first local oscillator 302, the first signal output port 202A, and the second signal output port 202B. There is further shown that the radio transceiver circuitry 120B of the donor antenna device 120 may include a controller 304, a first multiplexer 310, a first mixer 308, the first transceiver 306.

The first local oscillator 302 may be configured to generate a reference frequency, such as for the donor antenna device 120. Examples, the first local oscillator 302 may include but are not limited to voltage-controlled oscillator, a crystal oscillator, a ring oscillator, and the like. The controller 304 of the radio transceiver circuitry 120B may be configured convert the 5G RF signals captured from the outdoor 5G RAN node 102 in a first 5G frequency spectrum to a second 5G frequency spectrum for transmission of the captured 5G RF signals as analog RF signals over the one or more wired mediums 124A to 124D to the plurality of passive relay antenna devices 122A to 122H. Examples of the controller 304 may include but are not limited to a digital signal processor (DSP), a central processing unit (CPU), a field programmable gate array (FPGA), a combination of CPU and FPGA, or other control circuitry. In an implementation, the controller 304 of the radio transceiver circuitry 120B may be configured to use different frequency conversion techniques, such as mixing, filtering, and amplification, which may be employed to convert the 5G RF signals captured from the outdoor 5G RAN node 102 in the first 5G frequency spectrum to the second 5G frequency spectrum. By converting the first 5G frequency spectrum into the second 5G frequency spectrum, the radio transceiver circuitry 120B prepares the 5G RF signals in the second 5G frequency spectrum for seamless and efficient transmission of the 5G RF signals over the one or more wired mediums 124A to 124D and to the passive relay antenna devices 122A to 122H. The conversion may be beneficial to align the 5G RF signals with an optimal frequency range for transmission over the one or more wired mediums 124A to 124D ensuring minimal signal loss and interference. Furthermore, transmitting the 5G RF signals in analog RF format over the one or more wired mediums 124A to 124D may enhance reliability and stability, particularly in environments where wireless transmission may be prone to interference or signal degradation. In addition, by leveraging frequency conversion and wired transmission, the first DAS 116A may extend 5G RF signals coverage within the first building 118A or across larger areas, providing consistent and high-quality connectivity to end users within the first building 118A, ultimately enhancing the overall performance and reliability of the first DAS 116A.

Furthermore, the first transceiver 306 may be a combination of a transmitter and a receiver in a single device or module. The first transceiver 306 may be communicatively coupled with the donor antenna 120A, such as to receive the captured 5G RF signals. In an implementation, the first transceiver 306 may be configured to facilitate two-way communication by allowing the transmission and reception of the captured 5G RF signals on the same device. Examples of the first transceiver 306 may include but are not limited to a radio transceiver, a wireless transceiver, an optical transceiver, a microwave transceiver, and the like. The first mixer 308 may be communicatively coupled with the first multiplexer 310 as well as with the first transceiver 306. In an implementation, the first mixer 308 may be configured to perform different types of operation on the received 5G RF signals (e.g., frequency conversion, division, and the like), and provide analog RF signals to the first multiplexer 310. Examples of the first mixer 308 may include but are not limited to a digital mixer, analog mixer, frequency mixer, and the like. Similarly, examples of the first multiplexer 310 may include but are not limited to analog multiplexer, digital multiplexer, tree-structured multiplexer, and the like.

In an implementation, the donor antenna device 120 may include the first local oscillator 302, which may be configured to be synchronized based on the publicly broadcast synchronization signals to enable coherent transmission and reception over the one or more wired mediums 124A to 124D. The first local oscillator 302 may be configured to generate a reference frequency for the donor antenna device 120. In an implementation, the radio transceiver circuitry 120B may include the controller 304, which may be configured to estimate a carrier frequency offset (CFO) by analyzing synchronization signal blocks signal's phase rotation in a frequency domain for a carrier frequency synchronization with the outdoor 5G RAN node 102. In other words, the synchronization with the publicly broadcast synchronization signals from the outdoor 5G RAN node 102 may further include estimating the CFO by analyzing synchronization signal's phase rotation in a frequency domain in the frequency synchronization, and compensating for the CFO in the first local oscillator 302 to align the donor antenna device 120 to a carrier frequency of the outdoor 5G RAN node 102. In addition, the synchronization process involves estimating the CFO by analyzing the phase rotation of the synchronization signal blocks in the frequency domain. In an implementation, the controller 304 may be configured to compensate for the CFO in the first local oscillator 302 of the donor antenna device 120 to align the donor antenna 120A to the carrier frequency of the outdoor 5G RAN node 102. In other words, once the CFO is determined, the first local oscillator 302 may be adjusted or compensated to align the donor antenna device 120 precisely with the carrier frequency of the outdoor 5G RAN node 102.

FIG. 3B is a diagram illustrating communication between a donor antenna device and a passive relay antenna device in a distributed antenna system, in accordance with an exemplary embodiment of the disclosure. The FIG. 3B is explained in conjunction with elements from FIGS. 1A, 1B, 2A, 2B, 2C, and FIG. 3A. With reference to FIG. 3B, there is shown a diagram 300B that depicts the first DAS 116A, which includes the donor antenna device 120 and the third passive relay antenna device 122C. There is further shown that the donor antenna device 120 may include the first local oscillator 302, the first signal output port 202A, and the second signal output port 202B. There is further shown that the radio transceiver circuitry 120B of the donor antenna device 120 may include the controller 304, the first multiplexer 310, the first mixer 308, the first transceiver 306. There is further shown that the third passive relay antenna device 122C, which may include a second local oscillator 312, a second multiplexer 314, a second mixer 316, and a second transceiver 318. There is further shown a user equipment (UE) 320.

The second local oscillator 312 may work in a similar manner as that of the first local oscillator 302, such as to generate a reference frequency, such as for the third passive relay antenna device 122C. Examples of each of the second local oscillator 312 may include but are not limited to voltage-controlled oscillator, a crystal oscillator, a ring oscillator, and the like.

The second multiplexer 314 of the third passive relay antenna device 122C may be communicatively coupled with the donor antenna device 120, such as through the first wired medium 124A, to receive multiple inputs and provide a single output. In an implementation, the second multiplexer 314 may be configured to receive the analog RF signals from the donor antenna device 120. Examples of the second multiplexer 314 may include but are not limited to analog multiplexer, digital multiplexer, tree-structured multiplexer, and the like. The second mixer 316 may be communicatively coupled with the second multiplexer 314 as well as with the second transceiver 318. In an implementation, the second mixer 316 may be configured to perform different types of operation on the analog RF signals (e.g., frequency conversion, division, and the like), and provides modified analog RF signals to the second transceiver 318. Examples of the second mixer 316 may include but are not limited to a digital mixer, analog mixer, frequency mixer, and the like. Furthermore, the second transceiver 318 may also be referred to as a combination of a transmitter and a receiver in a single device or module. In an implementation, the second transceiver 318 may be configured to facilitate two-way communication by allowing the transmission and reception of modified analog RF signals on the same device. Examples of the second transceiver 318 may include but are not limited to a radio transceiver, a wireless transceiver, an optical transceiver, a microwave transceiver, and the like.

In an implementation, each of the donor antenna device 120 and the plurality of passive relay antenna devices 122A to 122H may include a local oscillator, which may be configured to be synchronized based on the publicly broadcast synchronization signals to enable coherent transmission and reception over the one or more wired mediums. In an implementation, the donor antenna device 120 may include the first local oscillator 302 and the third passive relay antenna device 122C may include the second local oscillator 312. In addition, the synchronization process involves estimating a Carrier Frequency Offset (CFO) by analyzing the phase rotation of synchronization signal blocks in the frequency domain. Once this CFO is determined, the first local oscillator 302 may be adjusted or compensated to align the donor antenna device 120 precisely with the carrier frequency of the outdoor 5G RAN node 102, such as a gNB.

In an implementation, the publicly broadcast synchronization signals intended for one or more indoor user equipment (UEs) may include a Primary Synchronization Signal (PSS) and a Secondary Synchronization Signal (SSS). The publicly broadcast synchronization signals intended for the one or more indoor UEs, such as for the UE 320 may further include broadcast channel information including system parameters and configuration for operation of the one or more indoor UEs, reference signals for channel estimation, synchronization and cell information, beamforming information, and cell identity.

In an implementation, each of the plurality of passive relay antenna devices 122A to 122H may be configured to determine a path loss to each user equipment (UE) of one or more indoor UEs in the first building 118A based on Channel State Information Reference Signals (CSI-RS) channel independent of the explicit coordination from the outdoor 5G RAN node 102. In an implementation, each of the plurality of passive relay antenna devices 122A to 122H may be configured to adjust transmit power based on the determined path loss. In an implementation, with the aid of a Radio Network Temporary Identifier (RNTI) and grant information obtained from the scheduling process, the third passive relay antenna devices 122C may be configured to correlate various CSI-RS resources to the currently active UE, such as the UE 320. This correlation may associate the specific CSI-RS resources with the UE 320 that have been scheduled for communication. Subsequently, the third passive relay antenna devices 122C of the first DAS 116A may conduct measurements on the reference signals associated with the UE 320. This involves averaging out noise by accumulating signals over multiple CSI-RS periods. By doing so, the first DAS 116A aims to enhance the reliability and accuracy of the measurements, providing a more robust representation of the channel conditions for the UE 320.

In an implementation, based on the Channel State Information Reference Signals (CSI-RS) measurements, the third passive relay antenna devices 122C may be configured to estimate the channel matrix corresponding to the UE 320. Subsequently, the third passive relay antenna devices 122C may be configured to compute a beamforming precoding matrix or beamforming vector, optimizing the directional transmission of signal power toward the UE 320. This beamforming vector may be dynamically updated in each CSI-RS period to adapt to the changing characteristics of the channel. Through this process, the first DAS 116A may optimize the beamforming based on real-time channel information, ensuring efficient and adaptive communication with the UE 320.

In accordance with an embodiment, the third passive relay antenna devices 122C may further be configured to determine a path loss to the UE 320 based on Channel State Information Reference Signals (CSI-RS) channel independent of the explicit coordination from the outdoor 5G RAN node 102. The third passive relay antenna devices 122C may further be configured to adjust transmit power based on the determined path loss. Based on the Channel State Information Reference Signals (CSI-RS), the third passive relay antenna devices 122C may be configured to estimate the propagation path loss by analyzing the received power levels of reference signals. This path loss estimate serves in determining the optimal transmit power needed to reach the UE 320. The calculated transmit power accounts for the effects of signal attenuation and helps ensure that the signal reaches the UE 320 with the required quality. Such path loss estimate may be updated in each CSI-RS period, aligning with the dynamic adjustments made during beamforming calculations. This iterative process ensures that the transmit power is continually optimized based on real-time channel conditions, contributing to efficient and adaptive wireless communication by the first DAS 116A.

In an implementation, a data propagation path of user data relayed through a network of the donor antenna device 120 and the plurality of passive relay antenna devices 122A to 122H may be analog without any digital decoding or encoding of the user data in the analog RF signals to reduce latency less than a threshold time. By virtue of bypassing the steps of decoding or encoding, the first DAS 116A may avoid the overhead associated with converting digital data into analog RF signals and vice versa. Furthermore, such a reduction in processing overhead contributes to lower latency in the transmission of the user data. As a results, there exists a direct transmission of the user data in analog form, which allows for a more direct path between the donor antenna device 120 and the plurality of passive relay antenna devices 122A to 122H without intermediate digital processing stages. This streamlined transmission path helps to minimize delays caused by data processing and routing, resulting in faster data delivery.

In an implementation, each of the donor antenna device 120 and the plurality of passive relay antenna devices 122A to 122H may be configured to receive control instructions over an out-of-band frequency channel from the central cloud server 114 in a control and management plane different from one or more 5G carrier frequencies operated in the data propagation path. In an implementation, the central cloud server 114 may be configured to communicate over an out-of-band frequency with the donor antenna device 120 and the plurality of passive relay antenna devices 122A to 122H to form and monitor a 5G wireless mesh network. The donor antenna device 120 and the plurality of passive relay antenna devices 122A to 122H may form a 5G wireless mesh network. Each of the donor antenna device 120 and the plurality of passive relay antenna devices 122A to 122H may be connected with each other and may form a backhaul, such as mmWave backhaul. In an implementation, utilizing mmWave for backhaul has advantages such as higher data transfer rates and increased bandwidth, making it well-suited for the demands of 5G networks. This design enables efficient and high-capacity communication between the nodes, contributing to the overall performance and reliability of the 5G wireless mesh network.

In an implementation, each of the plurality of passive relay antenna devices 122A to 122H may be configured to perform Multi-User, Multiple Input, Multiple Output (Mu-MIMO) to corresponding connected UEs via corresponding one of: mmWave New Radio Unlicensed (NR-U) links or mmWave New Radio (NR) licensed links. In an implementation, the third passive relay antenna device 122C may be configured to perform Mu-MIMO to the UE 320. In accordance with an embodiment, the re-configuration of the 5G wireless mesh network configuration may include an antenna re-configuration of the third passive relay antenna device 122C to adjust beamforming settings and Mu-MIMO configurations. This operation may optimize the beamforming settings and Mu-MIMO configurations. By reconfiguring the antenna settings, the third passive relay antenna device 122C of plurality of passive relay antenna devices 122A to 122H may dynamically adapt its beamforming, the technique that focuses signal transmission on specific directions, and Mu-MIMO configurations, which involve using multiple antennas for simultaneous communication. This adaptive approach enables the network to efficiently utilize spatial diversity, improving signal strength, reducing interference, and enhancing overall data transfer performance based on the dynamically changing demands and conditions within an indoor area for consistent high throughput communication within the 5G wireless mesh network.

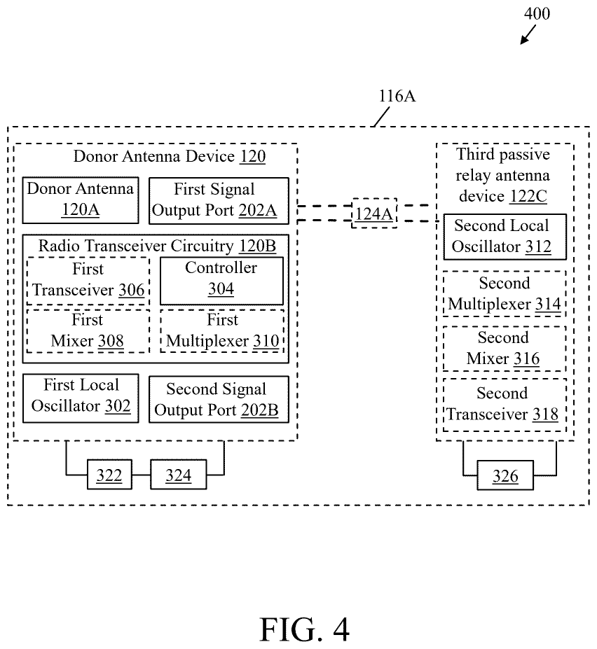

FIG. 4 is a diagram illustrating communication between a donor antenna device and a passive relay antenna device in a distributed antenna system, in accordance with an exemplary embodiment of the disclosure. FIG. 4 is explained in conjunction with elements from FIGS. 1A, 1B, 2A, 2B, 2C, 3A, and FIG. 3B. With reference to FIG. 4, there is shown a diagram 400 that depicts the first DAS 116A, which includes the donor antenna device 120 and the third passive relay antenna device 122C. There is further shown that the donor antenna device 120 may include the first local oscillator 302, the first signal output port 202A, and the second signal output port 202B. There is further shown that the radio transceiver circuitry 120B of the donor antenna device 120 may include the controller 304, the first multiplexer 310, the first mixer 308, the first transceiver 306. There is further shown that the third passive relay antenna device 122C, which may include the second local oscillator 312, the second multiplexer 314, the second mixer 316, and the second transceiver 318. There is further shown a converter 322, an integrated circuit 324, and a controller 326.

In an implementation, the first mixer 308 may be a nonlinear circuit that creates a new signal by multiplying two input signals together, which may be received from the first transceiver 306. In an implementation, the first mixer 308, which may be communicatively coupled with the first transceiver 306 and may be used to convert the frequency of the 5G RF signal. In an implementation, the first mixer 308 may further include two different mixers, such as a down conversion mixer and an up-conversion mixer. In such an implementation, the down conversion mixer may be configured to convert the 5G RF signal to a lower frequency signal (e.g., 250 MHz to 750 MHz). Similarly, the up-conversion mixer may be configured to convert the 5G RF signal to a higher frequency signal (e.g., 1250 MHz to 1750 MHZ).

The converter 322 may also be referred to as an analog to digital converter, such as a voltage or current that varies continuously over time, into a digital signal, which is a series of discrete values (1s and 0s). In an implementation, the converter 322 may be communicatively coupled with an output terminal of the first transceiver 306 of the donor antenna device 120 as well as an input terminal of the first mixer 308. In an implementation, the converter 322 may be configured to convert the RF signal received by the donor antennas 120A into a digital signal that can be processed by the integrated circuit 324. The integrated circuit 324 may also be referred to as a programable integrated circuit, which may be configured to receive the digital signal from the converter 322 and provide a modified signal to the first mixer 308 as well as to the first multiplexer 310. The first multiplexer 310 may include one or more filters, such as band-pass filter and a low-pass filter. In an implementation, the band-pass filter may allow signals within a certain frequency range to pass through while attenuating signals outside that range. In another implementation, the low-pass filter may allow signals below a certain frequency to pass through while attenuating signals above that frequency.

The first multiplexer 310 of the donor antenna device 120 may be communicatively coupled with the second multiplexer 314 of the third passive relay antenna device 122C through the first wired medium 124A, such as to transmit the captured 5G RF signals as analog RF signals. As a result, the second multiplexer 314 may be configured to receive the captured 5G RF signals as analog RF signals from the first multiplexer 310 of the donor antenna device 120. Thereafter, the second multiplexer may be configured to transmit the analog RF signals to the second mixer 316, which may work in a similar way as that of the first mixer 308, such as to provide an output signal to the second transceiver 318. After that, the second transceiver 318 may be configured to wirelessly re-broadcast the 5G RF signals to provide 5G coverage within the first building 118A. In an implementation, the second multiplexer 314 may be communicatively coupled with the controller 326, such as based on the received captured 5G RF signals from the first multiplexer 310, the second multiplexer 314 may be configured to provide one more instruction to the controller 326. Thereafter, based on the received one or more instructions, the controller 326 may be configured to control the operation of each of the second mixer 316 as well as the second transceiver 318, such as to wirelessly re-broadcast the 5G RF signals to provide 5G coverage within the first building 118A.

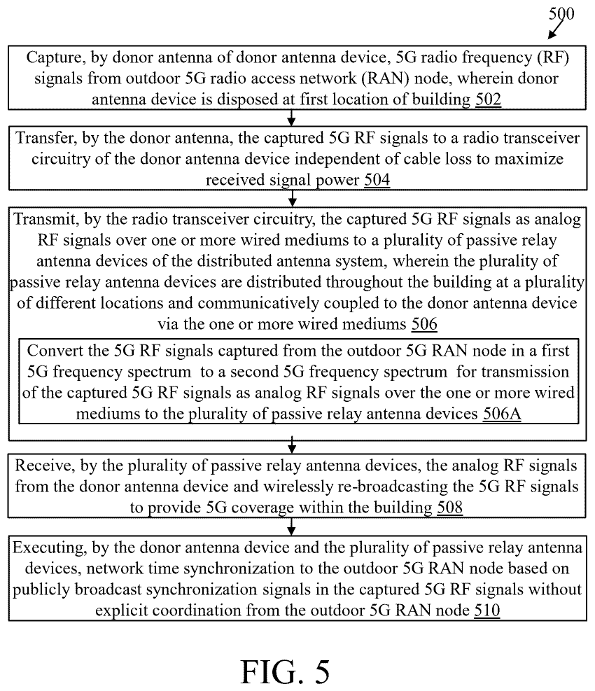

FIG. 5 is a flow chart of a method of operating a distributed antenna system for providing 5G wireless coverage within a building, in accordance with another exemplary embodiment of the disclosure. FIG. 5 is explained in conjunction with elements from FIGS. 1A, 1B, 2A, 2B, 3A, 3B, and 4. With reference to FIG. 5, there is shown a flowchart of a method 500 comprising exemplary operations 502 to 510. The method 500 may be implemented in each of the one or more DAS 116A to 116D, such as the first DAS 116A.

At 502, 5G radio frequency (RF) signals may be captured, by the donor antenna 120A of the donor antenna device 120, from the outdoor 5G RAN node 102, where the donor antenna device 120 may be disposed at a first location of a building (e.g., the first building 118A).

At 504, the captured 5G RF signals may be transferred, by the donor antenna 120A, to the radio transceiver circuitry 120B of the donor antenna device 120 independent of cable loss to maximize received signal power.

At 506, the captured 5G RF signals may be transmitted as analog RF signals by the radio transceiver circuitry 120B over the one or more wired mediums 124A to 124D to the plurality of passive relay antenna devices 122A to 122H of the distributed antenna system 116A. Moreover, the plurality of passive relay antenna devices 122A to 122H may be distributed throughout the first building 118A at a plurality of different locations and communicatively coupled to the donor antenna device 120 via the one or more wired mediums 124A to 124D. The operation 506 may include one or more sub-operations, such as operation 506A.

At 506A, the 5G RF signals captured from the outdoor 5G RAN node 102 may be converted from a first 5G frequency spectrum to a second 5G frequency spectrum for transmission of the captured 5G RF signals as analog RF signals over the one or more wired mediums 124A to 124D to the plurality of passive relay antenna devices 122A to 122H.

At 508, the analog RF signals from the donor antenna device 120) may be received by the plurality of passive relay antenna devices 122A to 122H, and the 5G RF signals may be wirelessly re-broadcasted to provide 5G coverage within the first building 118A.

At 510, the donor antenna device 120 and the plurality of passive relay antenna devices 122A to 122H, may be configured to execute network time synchronization to the outdoor 5G RAN node 102 based on publicly broadcast synchronization signals in the captured 5G RF signals without explicit coordination from the outdoor 5G RAN node 102.

There is further provided a computer program product for operating a distributed antenna system (e.g., the first DAS 116A) for providing 5G wireless coverage within the first building 118A, the computer program product may include a computer-readable storage medium having program instructions embodied therewith, the program instructions are executable by a system to cause the system to execute operations, the operations comprising, capturing, by the donor antenna 120A of the donor antenna device 120, 5G radio frequency (RF) signals from the outdoor 5G RAN node 102, such as the donor antenna device 120 is disposed at a first location of the first building 118A. The operations further comprise transferring, by the donor antenna 120A, the captured 5G RF signals to the radio transceiver circuitry 120B of the donor antenna device 120 independent of cable loss to maximize received signal power. The operations further comprise transmitting, by the radio transceiver circuitry 120B, the captured 5G RF signals as analog RF signals over one or more wired mediums 124A to 124D to the plurality of passive relay antenna devices 122A to 122H of the first DAS 116A, such as the plurality of passive relay antenna devices 122A to 122H are distributed throughout the first building 118A at a plurality of different locations and communicatively coupled to the donor antenna device 120 via the one or more wired mediums 124A to 124D. The operations further comprise receiving, by the plurality of passive relay antenna devices 122A to 122H, the analog RF signals from the donor antenna device 120 and wirelessly re-broadcasting the 5G RF signals to provide 5G coverage within the first building 118A. The operations further comprise executing, by the donor antenna device 120 and the plurality of passive relay antenna devices 122A to 122H, network time synchronization to the outdoor 5G RAN node 102 on publicly broadcast synchronization signals in the captured 5G RF signals without explicit coordination from the outdoor 5G RAN node 102.

While various embodiments described in the present disclosure have been described above, it should be understood that they have been presented by way of example, and not limitation. It is to be understood that various changes in form and detail can be made therein without departing from the scope of the present disclosure. In addition to using hardware (e.g., within or coupled to a central processing unit (“CPU”), microprocessor, micro controller, digital signal processor, processor core, system on chip (“SOC”) or any other device), implementations may also be embodied in software (e.g., computer readable code, program code, and/or instructions disposed in any form, such as source, object, or machine language) disposed for example in a non-transitory computer-readable medium configured to store the software. Such software can enable, for example, the function, fabrication, modeling, simulation, description and/or testing of the apparatus and methods described herein. For example, this can be accomplished through the use of general program languages (e.g., C, C++), hardware description languages (HDL) including Verilog HDL, VHDL, and so on, or other available programs. Such software can be disposed in any known non-transitory computer-readable medium, such as semiconductor, magnetic disc, or optical disc (e.g., CD-ROM, DVD-ROM, etc.). The software can also be disposed as computer data embodied in a non-transitory computer-readable transmission medium (e.g., solid state memory any other non-transitory medium including digital, optical, analog-based medium, such as removable storage media). Embodiments of the present disclosure may include methods of providing the apparatus described herein by providing software describing the apparatus and subsequently transmitting the software as a computer data signal over a communication network including the internet and intranets.

It is to be further understood that the system described herein may be included in a semiconductor intellectual property core, such as a microprocessor core (e.g., embodied in HDL) and transformed to hardware in the production of integrated circuits. Additionally, the system described herein may be embodied as a combination of hardware and software. Thus, the present disclosure should not be limited by any of the above-described exemplary embodiments but should be defined only in accordance with the following claims and their equivalents.

What is claimed is:

1. A distributed antenna system for providing 5G wireless coverage within a building, comprising:
a donor antenna device disposed at a first location of the building to communicate with an outdoor 5G radio access network (RAN) node; and
a plurality of passive relay antenna devices distributed throughout the building at a plurality of different locations and communicatively coupled to the donor antenna device via one or more wired mediums,
wherein the donor antenna device comprises a donor antenna and a radio transceiver circuitry integrated and connected with the donor antenna independent of a physical cable,
and wherein the donor antenna is configured to capture 5G radio frequency (RF) signals from the outdoor 5G RAN node and transfer the captured 5G RF signals to the radio transceiver circuitry independent of cable loss to maximize received signal power,
and wherein the radio transceiver circuitry is configured to transmit the captured 5G RF signals as analog RF signals over the one or more wired mediums to the plurality of passive relay antenna devices,
and wherein the plurality of passive relay antenna devices are configured to receive the analog RF signals from the donor antenna device and wirelessly re-broadcast the 5G RF signals to provide 5G coverage within the building,
and wherein the donor antenna device and the plurality of passive relay antenna devices are configured to execute network time synchronization to the outdoor 5G RAN node based on publicly broadcast synchronization signals in the captured 5G RF signals without explicit coordination from the outdoor 5G RAN node.

2. The distributed antenna system according to claim 1, wherein the one or more wired mediums is one of: a coaxial cable or an Ethernet cable installed within the building.

3. The distributed antenna system according to claim 1, wherein the radio transceiver circuitry comprises a controller configured to convert the 5G RF signals captured from the outdoor 5G RAN node in a first 5G frequency spectrum to a second 5G frequency spectrum for transmission of the captured 5G RF signals as analog RF signals over the one or more wired mediums to the plurality of passive relay antenna devices.

4. The distributed antenna system according to claim 1, wherein the donor antenna device further comprises a first signal output port and a second signal output port, each connected to the radio transceiver circuitry for concurrent relay of the captured 5G RF signals as analog RF signals over the one or more wired mediums from the donor antenna device,
and wherein the first signal output port is connected to a first passive relay device of the plurality of passive relay antenna devices via a first wired medium to serve a first zone in the building and the second signal output port is connected to a second passive relay device of the plurality of passive relay antenna devices via a second wired medium to serve a second zone in the building.

5. The distributed antenna system according to claim 1, wherein the donor antenna device further comprises a first signal output port and a second signal output port, each connected to the radio transceiver circuitry for concurrent relay of the captured 5G RF signals as analog RF signals in a hybrid wired and wireless medium from the donor antenna device,
wherein the first signal output port is connected to a first passive relay device of the plurality of passive relay antenna devices via a first wired medium to serve a first zone in the building and the second signal output port is connected to a RF antenna configured to relay a wireless radio frequency signal towards a second passive relay device of the plurality of passive relay antenna devices to serve a second zone in the building.

6. The distributed antenna system according to claim 1, wherein the donor antenna of the donor antenna device is further configured to switch between two different carrier frequencies from two different wireless carrier networks for the capture of the 5G RF signals alternatively from two different RAN nodes based on an instruction received from a central cloud server.

7. The distributed antenna system according to claim 1, wherein the donor antenna of the donor antenna device is further configured to concurrently receive two different carrier frequencies from two different wireless carrier networks for concurrent capture of the 5G RF signals from two different RAN nodes based on an instruction received from a central cloud server.

8. The distributed antenna system according to claim 7, wherein the radio transceiver circuitry is configured to aggregate the 5G RF signals from the two different RAN nodes into a single composite signal stream for transmission as the analog RF signals over the one or more wired mediums to the plurality of passive relay antenna devices.

9. The distributed antenna system according to claim 1, wherein each of the donor antenna device and the plurality of passive relay antenna devices is further configured to adjust at least one operating parameter based on a control instruction received from a central cloud server.

10. The distributed antenna system according to claim 1, wherein the at least one operating parameter comprises one or more of: a gain level at each of the plurality of passive relay antenna devices, a routing path among the plurality of passive relay antenna devices, a channel allocation, a bandwidth allocation, a beamforming parameter, and an antenna combining instruction.

11. The distributed antenna system according to claim 1, wherein each of the donor antenna device and the plurality of passive relay antenna devices further comprises a local oscillator configured to be synchronized based on the publicly broadcast synchronization signals to enable coherent transmission and reception over the one or more wired mediums.

12. The distributed antenna system according to claim 1, wherein the publicly broadcast synchronization signals intended for one or more indoor user equipment (UEs) comprise a Primary Synchronization Signal (PSS) and a Secondary Synchronization Signal (SSS).

13. The distributed antenna system according to claim 1, wherein the radio transceiver circuitry comprises a controller configured to estimate a carrier frequency offset (CFO) by analyzing synchronization signal blocks signal's phase rotation in a frequency domain for a carrier frequency synchronization with the outdoor 5G RAN node.

14. The distributed antenna system according to claim 13, wherein the controller is further configured to compensate for the CFO in a local oscillator of the donor antenna device to align the donor antenna to the carrier frequency of the outdoor 5G RAN node.

15. The distributed antenna system according to claim 1, wherein each of the plurality of passive relay antenna devices is further configured to:
determine a path loss to each user equipment (UE) of one or more indoor UEs in the building based on Channel State Information Reference Signals (CSI-RS) channel independent of the explicit coordination from the outdoor 5G RAN node; and
adjust transmit power from each of the plurality of passive relay antenna devices based on the determined path loss.

16. The distributed antenna system according to claim 1, wherein a data propagation path of user data relayed through a network of the donor antenna device and the plurality of passive relay antenna devices is analog without any digital decoding or encoding of the user data in the analog RF signals to reduce latency less than a threshold time.

17. The distributed antenna system according to claim 16, wherein each of the donor antenna device and the plurality of passive relay antenna devices is further configured to receive control instructions over an out-of-band frequency channel from a central cloud server in a control and management plane different from one or more 5G carrier frequencies operated in the data propagation path.

18. The distributed antenna system according to claim 1, wherein each of the plurality of passive relay antenna devices is further configured to perform Multi-User, Multiple Input, Multiple Output (Mu-MIMO) to corresponding connected UEs via corresponding one of: mm Wave New Radio Unlicensed (NR-U) links or mmWave New Radio (NR) licensed links.

19. A method of operating a distributed antenna system for providing 5G wireless coverage within a building, the method comprising:
capturing, by a donor antenna of a donor antenna device, 5G radio frequency (RF) signals from an outdoor 5G radio access network (RAN) node, wherein the donor antenna device is disposed at a first location of the building;
transferring, by the donor antenna, the captured 5G RF signals to a radio transceiver circuitry of the donor antenna device independent of cable loss to maximize received signal power;
transmitting, by the radio transceiver circuitry, the captured 5G RF signals as analog RF signals over one or more wired mediums to a plurality of passive relay antenna devices of the distributed antenna system, wherein the plurality of passive relay antenna devices are distributed throughout the building at a plurality of different locations and communicatively coupled to the donor antenna device via the one or more wired mediums;
receiving, by the plurality of passive relay antenna devices, the analog RF signals from the donor antenna device and wirelessly re-broadcasting the 5G RF signals to provide 5G coverage within the building; and
executing, by the donor antenna device and the plurality of passive relay antenna devices, network time synchronization to the outdoor 5G RAN node based on publicly broadcast synchronization signals in the captured 5G RF signals without explicit coordination from the outdoor 5G RAN node.

20. A computer program product for operating a distributed antenna system for providing 5G wireless coverage within a building, the computer program product comprising a computer-readable storage medium having program instructions embodied therewith, the program instructions are executable by a system to cause the system to execute operations, the operations comprising:
capturing, by a donor antenna of a donor antenna device, 5G radio frequency (RF) signals from an outdoor 5G radio access network (RAN) node, wherein the donor antenna device is disposed at a first location of the building;
transferring, by the donor antenna, the captured 5G RF signals to a radio transceiver circuitry of the donor antenna device independent of cable loss to maximize received signal power;
transmitting, by the radio transceiver circuitry, the captured 5G RF signals as analog RF signals over one or more wired mediums to a plurality of passive relay antenna devices of the distributed antenna system, wherein the plurality of passive relay antenna devices are distributed throughout the building at a plurality of different locations and communicatively coupled to the donor antenna device via the one or more wired mediums;
receiving, by the plurality of passive relay antenna devices, the analog RF signals from the donor antenna device and wirelessly re-broadcasting the 5G RF signals to provide 5G coverage within the building; and
executing, by the donor antenna device and the plurality of passive relay antenna devices, network time synchronization to the outdoor 5G RAN node based on publicly broadcast synchronization signals in the captured 5G RF signals without explicit coordination from the outdoor 5G RAN node.
